(19) United States
(12) Patent Application Publication
(10) Pub. No.: US 2005/0140138 A1
(43) Pub. Date: Jun. 30, 2005

(54) Locking hydraulic fitting for a dispensing apparatus

(75) Inventors: David J. Byerly, Lawrenceville, GA (US); George J. Pais, Cumming, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 11/059,957

(22) Filed: Feb. 17, 2005

Related U.S. Application Data
(63) Continuation-in-part of application No. 10/698,274, filed on Oct. 31, 2003.
(60) Provisional application No. 60/640,679, filed on Dec. 30, 2004.

(51) Int. Cl. F16L 35/00

(52) U.S. Cl. 285/260

(57) ABSTRACT

A locking hydraulic fitting for establishing a fluid connection with a fluid manifold, such as a manifold of a dispensing apparatus. The hydraulic fitting includes a body with a threaded portion capable of being engaged with a threaded inlet or another threaded portion of the manifold. The body of the hydraulic fitting hydraulically couples a fluid channel of the manifold with a fluid supply conduit. The hydraulic fitting includes a lock member configured to prevent rotation of the threaded portion of the hydraulic fitting relative to the threaded inlet or other threaded portion of the manifold.

### CROSS REFERENCE TO RELATED APPLICATIONS

This application claims the benefit of U.S. Provisional Application No. 60/640,679, filed Dec. 30, 2004, the disclosure of which is hereby incorporated by reference herein in its entirety. This application is also a continuation-in-part of U.S. Ser. No. 10/698,274, filed Oct. 31, 2003, the disclosure of which is hereby incorporated by reference herein in its entirety.

### FIELD OF THE INVENTION

The invention relates generally to dispensing apparatus, and, more particularly, to dispensing apparatus having threaded hydraulic fittings for conveying liquids.

### BACKGROUND OF THE INVENTION

Handheld dispensers have many commercial and industrial applications for dispensing liquids such as hot melt adhesives, sealants and other thermoplastic materials. Handheld dispensers are routinely coupled to a liquid source by a supply conduit that supplies pressurized liquid to the dispenser. A swivel hydraulic fitting is frequently used for rotatably coupling the supply conduit to the dispenser. The swivel hydraulic fitting prevents twisting of the supply conduit and improves the operator's ability to orient the handheld dispenser relative to the supply conduit.

Common swivel hydraulic fittings for a handheld dispenser include a spherical-shaped ball captured in a rotatable engagement with a socket inside a housing, such as the hydraulic fitting disclosed in U.S. Pat. No. 5,507,534. The supply conduit is connected to a coupling located at the free end of a stem having an opposite end coupled with the ball. Defined along the length of the stem is a liquid passageway that extends to approximately the centerpoint of the ball. Radial passageways extend from the liquid passageway to a liquid chamber defined inside the hydraulic fitting that transfers the liquid from the liquid passageway in the stem to the handheld dispenser. As the ball rotates and tilts inside the socket, flow in the liquid pathway defined inside the hydraulic fitting from the supply conduit to the handheld dispenser is uninterrupted and continuous. This type of swivel hydraulic fitting advantageously relieves axially-directed internal forces applied to the ball by the pressurized liquid in the liquid pathway, which reduces binding as the ball tilts and rotates relative to the socket. The swivel hydraulic fitting also has an extended operational life as premature wear of the ball and socket is reduced.

Nevertheless, there is still a need for improvements in relation to solving the same or similar axial loading problems arising from axially directed external forces or pull loads applied to the conduit that are subsequently transferred to the swivel member. External axial pull loads are applied to the hydraulic fitting when, for example, the supply conduit snags or catches on objects in the work environment of the operator. External axial pull loads are also applied to the supply conduit by the weight of the supply conduit itself.

Another concern with such swivel hydraulic fittings is that threaded components may loosen during use because of torsional forces applied externally to one threaded component, but not to the other threaded component. Typically, these torsional forces are applied to the supply conduit by the axial pull loads experienced as the handheld dispenser is used and are subsequently transferred to the swivel member. As the threaded components loosen, pressurized liquid may leak between the threaded components of the hydraulic fitting.

It would be desirable, therefore, to lock engaged threaded components in a hydraulic fitting against torsional forces that, if otherwise unbalanced, would act to loosen the engagement between the threaded components.

### SUMMARY

In one embodiment of the present invention, a lock member includes a collar capable of being positioned between the engaged threaded portions of a hydraulic fitting and a manifold so as to prevent relative rotation between the threaded portions. The collar includes a threaded opening and a portion capable of being engaged with the manifold to prevent relative rotation between the collar and the manifold. The lock member further includes a threaded member having a threaded engagement with the threaded opening. The threaded member has a section capable of being placed in contact with the hydraulic fitting when the threaded portions are engaged so as to prevent rotation between the collar and the hydraulic fitting.

In another embodiment of the present invention, a hydraulic fitting for transferring a fluid from a supply conduit to a manifold includes a body having a threaded portion capable of being engaged with a threaded portion of the manifold. The body hydraulically couples a fluid channel of the manifold with the supply conduit when the threaded portions are engaged. The apparatus further includes a lock member configured to prevent rotation of the threaded portions relative to each other, when the threaded portions are engaged. The lock member may be provided as a separate component from the body of the hydraulic fitting. Alternatively, the hydraulic fitting may be provided as a component of a fluid dispenser.

In another aspect, a method of transferring a fluid includes mechanically coupling a threaded portion of a hydraulic fitting with a threaded portion of a manifold, hydraulically coupling a first end of a fluid passageway in the hydraulic fitting with a supply conduit, and hydraulically coupling a second end of the fluid passageway with an inlet of the manifold. The method further includes mutually engaging the hydraulic fitting and the manifold with a lock member to prevent relative rotation between the threaded portions.

In accordance with the preferred embodiment of the invention, torsional forces applied to the swivel hydraulic fitting, for example from axial pull loads, do not result in loosening of threaded components in the fitting. Instead, the relative rotation of these threaded components is prevented by the implementation of a lock member. Consequently, torsional forces created when the dispenser is moved are ineffective for loosening the tightened threaded components.

These and other benefits and advantages of the present invention shall become more apparent from the accompanying drawings and description thereof.

### BRIEF DESCRIPTION OF THE FIGURES

The accompanying drawings, which are incorporated in and constitute a part of this specification, illustrate embodiments of the invention and, together with a general description of the invention given above, and the detailed description given below, serve to explain the principles of the invention.

FIG. 1 is a side perspective view of a dispensing handgun incorporating a swivel hydraulic fitting constructed in accordance with the principles of the invention;

FIG. 2 is a cross-sectional view of a portion of FIG. 1 taken generally along the mid-plane of FIG. 1 in which an outward axial force is applied to the stem;

FIG. 3 is a cross-sectional view similar to FIG. 2 in which an inward axial force is applied to the stem;

FIG. 4 is an exploded view of a portion of the swivel fitting of FIG. 1;

FIG. 5 is a top view in partial cross-section taken along line 5-5 of FIG. 1; and

FIG. 6 is a top view in partial cross-section taken along line 6-6 of FIG. 1.

### DETAILED DESCRIPTION OF THE PREFERRED EMBODIMENT

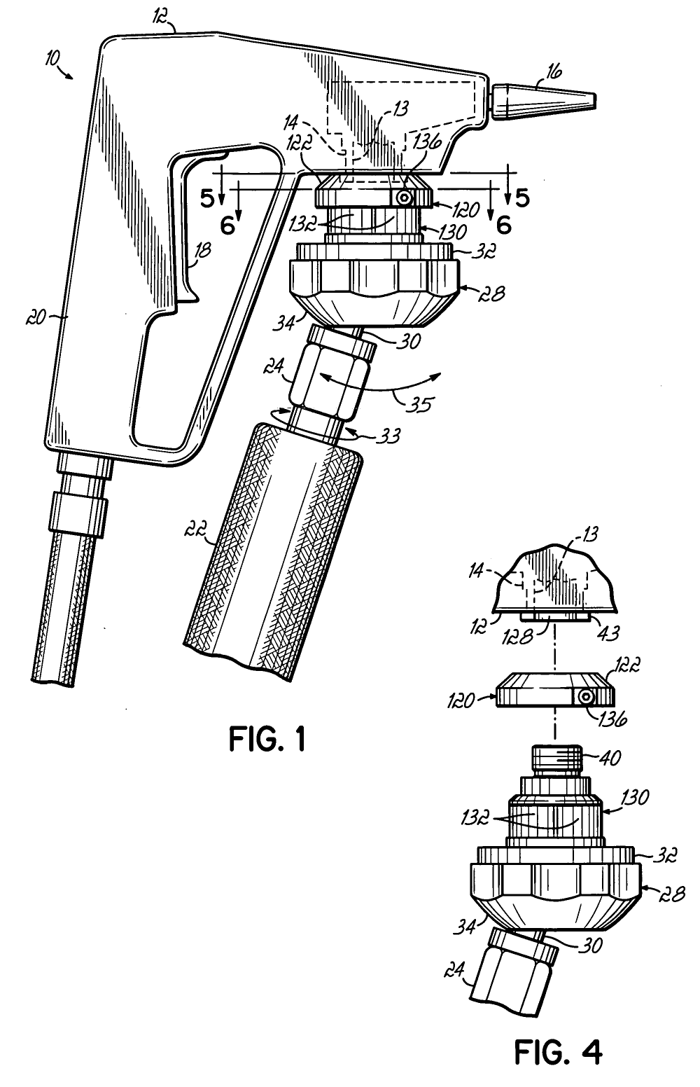

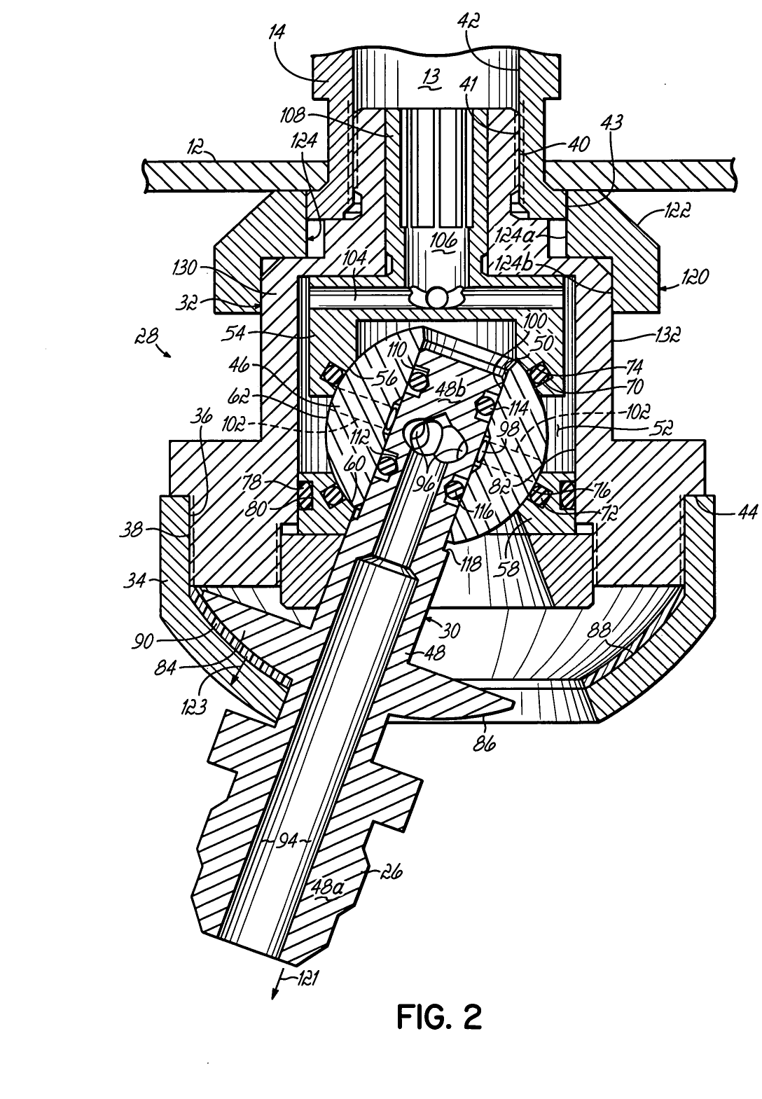

With reference to FIGS. 1 and 2, a handheld dispenser 10 generally includes a body 12 housing a fluid manifold 14 with an internal fluid channel or pathway 13 leading to a nozzle tip 16, which has an internal fluid channel coupled with the fluid pathway 13 and an exit orifice from which fluid or liquid is dispensed from the fluid channel. A handgrip 20 of the dispenser body 12 is shaped to be grasped by a human hand for moving the handheld dispenser 10 to orient the nozzle tip 16 relative to an object receiving the dispensed fluid or liquid. Handheld dispenser 10 may be operated in a vertical orientation, a horizontal orientation, or any intermediate orientation between vertical and horizontal.

References herein to terms such as “vertical”, “horizontal”, etc. are made by way of example, and not by way of limitation, to establish a frame of reference. It is understood various other frames of reference may be employed for purposes of describing the invention without departing from the spirit and scope of the invention.

Positioned in the fluid pathway 13 defined inside the fluid manifold 14 is a valve element (not shown) movable between opened and closed conditions to permit liquid flow through the internal fluid pathway 13 to the channel and exit orifice of nozzle tip 16. This affords an operator the ability to regulate and interrupt the stream of liquid dispensed from the handheld dispenser 10. The valve element is operated by manually actuating or otherwise depressing an external trigger 18 in reaction to which the valve element moves to the opened condition for permitting liquid to flow to the nozzle tip 16, and be dispensed, as a spray or stream from the exit orifice in the nozzle tip 16. The flow volume through the fluid pathway 13 to the nozzle tip 16 may be regulated by the degree to which the operator depresses trigger 18. Releasing the trigger 18 discontinues the flow of liquid through the fluid pathway 13 of the fluid manifold 14 to the nozzle tip 16 and provides the closed condition.

A supply hose or conduit 22 is removably attached to the handheld dispenser 10 by a female hydraulic coupling element 24 for connecting with a complementary male hydraulic coupling element 26 (FIG. 2) of a hydraulic fitting 28 constructed in accordance with the principles of the invention. The hydraulic coupling elements 24, 26 are preferably threaded coupling members. Liquid is pumped or otherwise supplied from a pressurized liquid source to the fluid manifold 14 of the handheld dispenser 10 through an internal lumen extending along the length of the supply conduit 22. Supply conduit 22 may be insulated and/or heated for reducing radially-outward heat transfer that would otherwise cool heated liquids flowing through the internal lumen and may also include temperature sensing. The liquid supplied to the handheld dispenser 10 by supply conduit 22 may be, for example, a heated thermoplastic material or a hot melt adhesive.

The principles of the invention may also be applicable to other types of handheld dispensers including, but not limited to, paint spray applicators, fuel dispensers and pneumatic tools. Other types of non-handheld dispensers supported by a structural framework may also benefit from application of the principles of the present invention.

With reference to FIGS. 1-3, the hydraulic fitting 28 generally includes a swivel member 30, a main body or housing 32, and a dome-shaped cap 34 having an internally-threaded portion 36 that attaches to an externally-threaded portion 38 of the housing 32. The threaded attachment of the cap 34 to the housing 32 secures the swivel member 30 within the housing 32. Another threaded portion or region 40 on the housing 32 mates with a threaded portion 41 of the fluid manifold 14, preferably defined by the threads on an internally-threaded inlet 42 to the internal fluid pathway 13 of the manifold 14. Inlet 42 is defined on a neck 43 projecting from the fluid manifold 14. A circumferential shoulder 44 defined in housing 32 adjacent to the externally threaded portion 38 defines a stop that limits tightening of the cap 34.

The swivel member 30 includes a spherical-shaped ball member or ball 46 and a stem 48 having a leading end extending into a bore 50 extending through the ball 46. A portion of the stem 48 projects from the housing 32 so that hydraulic coupling element 26 can be connected with hydraulic coupling element 24 of supply conduit 22. Stem 48 is axially-movable over a limited range of axial movement relative to the ball 46, as detailed below. The swivel member 30 and portions of the housing 32 surrounding the ball 46 constitute a ball-in-socket joint, as appreciated by persons of ordinary skill in the art, in which the stem 48 is movable relative to the housing 32 independent of the ball 46.

Ball 46 is mounted within the housing 32 for rotation and limited angular displacement relative to the housing 32. To that end, a socket assembly situated inside a fluid cavity 52 defined inside the housing 32 includes an upper cup-shaped socket 54 carrying a circumferential, concave bearing surface 56 and a floating sealing member 58 carrying another circumferential, concave bearing surface 60. The generally confronting bearing surfaces 56, 60 each have a surface area that contacts a convex outer surface 62 of the ball 46 for guiding the swivel member 30 as it rotates and tilts relative to the housing 32. The curvature of the convex outer surface 62 of the ball 46 corresponds to the curvature of the concave bearing surfaces 56, 60.

The stem 48 and ball 46 are freely rotatable through a continuum of multiple different angles, typically by a full 360°, relative to the stationary housing 32, as indicated by the double-headed arrow labeled with reference numeral 33 (FIG. 1), about a swivel axis extending along the length of stem 48. The stem 48 and ball 46 may also be freely tilted or pivoted relative to the housing 32 through a plurality of angles, as indicated by the double-headed arrow labeled with reference numeral 35 (FIG. 1). Typically, the stem 48 and ball 46 are capable of tilting through an angle of less than about 20°, although the present invention is not so limited. The supply conduit 22 and hydraulic coupling element 24 move along with the stem 48. The hydraulic fitting 28 may assume various different angles and rotational orientations as the dispenser 10 is grasped by handgrip 20 and moved by the operator to orient the nozzle tip 16 relative to the object receiving the dispensed liquid.

With reference to FIG. 2, resilient elastomer o-rings 70, 72 held within annular grooves 74, 76 inscribed about a circumferential portion of a corresponding one of the bearing surfaces 56, 60 and compressed against the convex outer surface 62 of the ball 46 provide fluid-tight dynamic fluid seals as the swivel member 30 rotates and tilts. The annular grooves 74, 76 are oriented angularly relative to the ball 46 so that each has a mouth that opens toward the convex outer surface 62 and radially relative to the center point of ball 46. The axial spacing between the socket 54 and floating sealing member 58 is such that the ball 46 has a dynamic sliding fit with o-rings 70, 72. The annular grooves 74, 76 in bearing surfaces 56, 60 and o-rings 70, 72 cooperate to provide an efficient fluid sealing action against the ball 46 without appreciably impairing relative rotation and tilting between the ball 46 and the socket assembly. An elastomer o-ring 78 received in an annular groove 80 encircling an outer surface of sealing member 58 is compressed against an inner surface 82 of the housing 32 to provide a static fluid seal.

Extending radially outward from a first portion 48a of the stem 48 of swivel member 30 is an annular flange 84 having a convex curved surface 86 facing toward an inwardly-facing concave surface 88 of the dome-shaped cap 34. A bearing component 90 inserted into the space defined between the curved surfaces 86, 88 has a curvature that conforms to the curvature of each of the curved surfaces 86, 88. The bearing component 90 may be a gasket or a coating applied to one or both of the curved surfaces 86, 88. Preferably, the bearing component 90 is a gasket that is stationary relative to the movement of the flange 84.

With continued reference to FIG. 2, bearing component 90 is formed of a material having a relatively low coefficient of friction with the material forming the annular flange 84 so that the effect of friction on movement of the flange relative to the stationary cap 34 is reduced. Specifically, the coefficient of sliding or kinetic friction of the material forming bearing component 90 against the material forming the annular flange 84 is less than, and preferably significantly less than, the coefficient of kinetic friction between the materials forming the curved surfaces 86, 88, usually a steel on steel contact. The material forming bearing component 90 should be stable at the temperature of the dispensed liquid, which transfers heat to the hydraulic fitting 28 if the liquid is heated. The material forming the bearing component 90 may be, for example, a wear resistant polymer such as polytetrafluoroethylene (PTFE), the homopolymer of tetrafluoroethylene sold under the trademark TEFLON by DuPont (Wilmington, Del.), or Rulon®, which is a filled form of tetrafluoroethylene.

Extending axially along the length of the stem 48 is a liquid passageway 94 that communicates with a plurality of cross-drilled radial passageways 96 that transfer liquid to an annular liquid cavity 98 defined in an inwardly-facing cylindrical side wall 100 defining bore 50 in which a second portion 48b of stem 48 is received. Opposite ends of the side wall 100 are chamfered. The radial passageways 96 communicate with the liquid cavity 98 for all possible orientations of the hydraulic fitting 28. Radial passageways 102 extending through the ball 46 transfer liquid from the liquid cavity 98 to fluid cavity 52 inside the housing 32. Extending through socket 54 are radial passageways 104 that transfer liquid from the fluid cavity 52 to a liquid passageway 106 extending axially through a neck 108 of socket 54. The liquid passageway 106 couples the hydraulic fitting 28 with the internal fluid manifold 14 of the handheld dispenser 10.

With continued reference to FIG. 2, the outer diameter of the second portion 48b of the stem 48 is smaller than the diameter of bore 50 so that stem 48 has adequate clearance to freely move within bore 50. Spaced along the axial length of the stem 48 are two inscribed circumferential grooves 110, 112 each holding one of a corresponding pair of resilient elastomer o-rings 114, 116, which are compressed against the inwardly-facing cylindrical side wall 100 surrounding bore 50. The respective mouth of each groove 110, 112 opens toward the cylindrical side wall 100 and the o-rings 114, 116 are dimensioned relative to the grooves 110, 112 so that, when uncompressed, a portion of each o-ring 114, 116 projects above the lip of the open mouth. When compressed by contact against the ball 46 in the assembled state, the o-rings 114, 116 preferably space the ball 46 from the stem 48 so that the cylindrical side wall 100 and the second portion 48b of stem 48 have a non-contacting relationship.

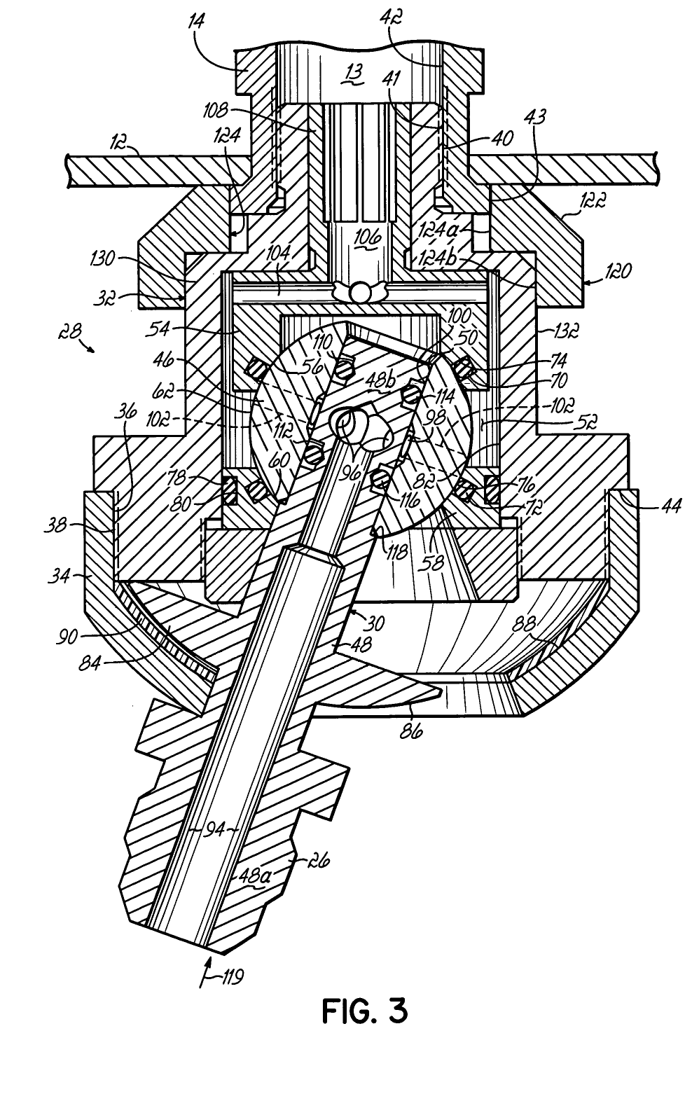

The axial travel range of the stem 48 relative to the ball 46 is limited by contact, at an inward extremum of the travel range, between a shoulder 118 defined at the junction between the portions 48a,b of stem 48 and the convex outer surface 62 of ball 46 and by contact between the curved surfaces 86, 88 at an outward extremum of the travel range. If the stem 48 is pushed inwardly relative to the ball 46 by an inwardly-directed axial force, generally indicated by reference numeral 119 on FIG. 3, applied to the supply conduit 22 (FIG. 1) and stem 48, shoulder 118 contacts the convex outer surface 62. As a result, the leading tip of first portion 48a of the stem 48 cannot protrude beyond the convex outer surface 62 of the ball 46 and the radial passageways 96 remain in constant fluid communication with the liquid cavity 98.

If the stem 48 is pulled outwardly relative to the ball 46 by an outwardly-directed axial force, generally indicated by reference numeral 121 on FIG. 2, applied to the supply conduit 22 and stem 48 the curved surfaces 86, 88 contact and halt outward movement or withdrawal of the stem 48. As a result, the applied axial force 121 is transferred from the stem 48 to the cap 34, as diagrammatically indicated by arrow 123, and subsequently to the housing 32 and ultimately to the dispenser 12 as the dispenser 12, housing 32 and cap 34 comprise a unitary structure. Fluid communication is continuous between the radial passageways 96 and the liquid cavity 98 as the stem 48 moves inward and outward. Under normal working conditions, the stem 48 will be pulled outwardly relative to the ball 46, as the weight of the supply conduit 22 will apply an uninterrupted outward axial force to the stem 48. Additional axial forces may be applied to the stem 48 when the supply conduit 22 snags or catches against external objects in the operator's work environment.

The action of the stem 48 in response to the outward axial force 121 (FIG. 2) isolates the ball 46 so that the axial force 121 applied in an outward direction is not transferred to the ball 46. Instead, outward axial forces are transferred from the stem 48 to the cap 34 and transferred serially to the housing 32 and dispenser 12, which collectively constitute a rigid body that dampens the outward axial force applied to stem 48.

Hydraulic fitting 28 has a construction that is compatible with dispensing fluids like hot melt materials that are converted, when heated, from a room-temperature solid to a liquid state. However, it should be understood that the methods and apparatus of the present invention are believed to be equally applicable for use in connection with the dispensing of other heated and unheated fluids. In addition, the principles of the invention may be applicable to hydraulic fittings having a construction that does not permit tilting, rotation, or both movements.

In use and with reference to FIGS. 1 and 2, liquid is directed along the length of the stem 48 through liquid passageway 94 and flows through radial passageways 96 in the stem 48, the annular liquid cavity 98, the radial passageways 102 in ball 46, the fluid cavity 52, and the radial passageways 104 in socket 54 to the liquid passageway 106 coupling the hydraulic fitting 28 with the internal fluid manifold 14 of the handheld dispenser 10. As the operator moves about carrying the handheld dispenser 10, the hydraulic fitting 28 rotates and tilts to accommodate changes in orientation while retaining an open fluid path so that liquid flow is uninterrupted to the handheld dispenser 10.

Axial forces 121 (FIG. 2) pulling on stem 48 cause the stem 48 to move outwardly relative to the ball 46, while the o-rings 114, 116 maintain a fluid-tight seal with the sidewall 100 surrounding bore 50. The axial forces 121 are transferred from the stem 48 to the cap 34 by contact between the curved surfaces 86, 88, as mediated by bearing component 90, and subsequently through the housing 32 to the handheld dispenser 10. More specifically, axial forces 121 applied to the stem 48 are transferred from the flange 84 to the dome-shaped cap 34 through the threaded engagement between the threaded portions 36 and 38, through the housing 32, and through the threaded engagement between the threaded region 40 and the threaded inlet 42 to the handheld dispenser 10. As a result, such axial forces 121 applied to the stem 48 are not transferred with a significant magnitude or at all to the ball 46, which reduces the forces applied to the o-rings 114, 116 and operates to extend the longevity of the o-rings 114, 116. In particular, the operating lifetime of o-ring 116 is lengthened, as the predominately applied outward axial force 121 that would otherwise have been transferred to o-ring 116 is instead transferred by the flange 84 to the cap 34.

With reference to FIGS. 1, 2, 4, 5, and 6, an annular lock member 120 is positioned between the dispenser body 12 and the hydraulic fitting 28. The lock member 120 operates to prevent unwanted relative rotation and loosening between the threaded region 40 on the housing 32 and the internally-threaded inlet 42 of the fluid manifold 14. A collar 122 of the lock member 120 includes a stepped-diameter central bore 124 through which the threaded region 40 is engaged with the internally threaded portion of inlet 42.

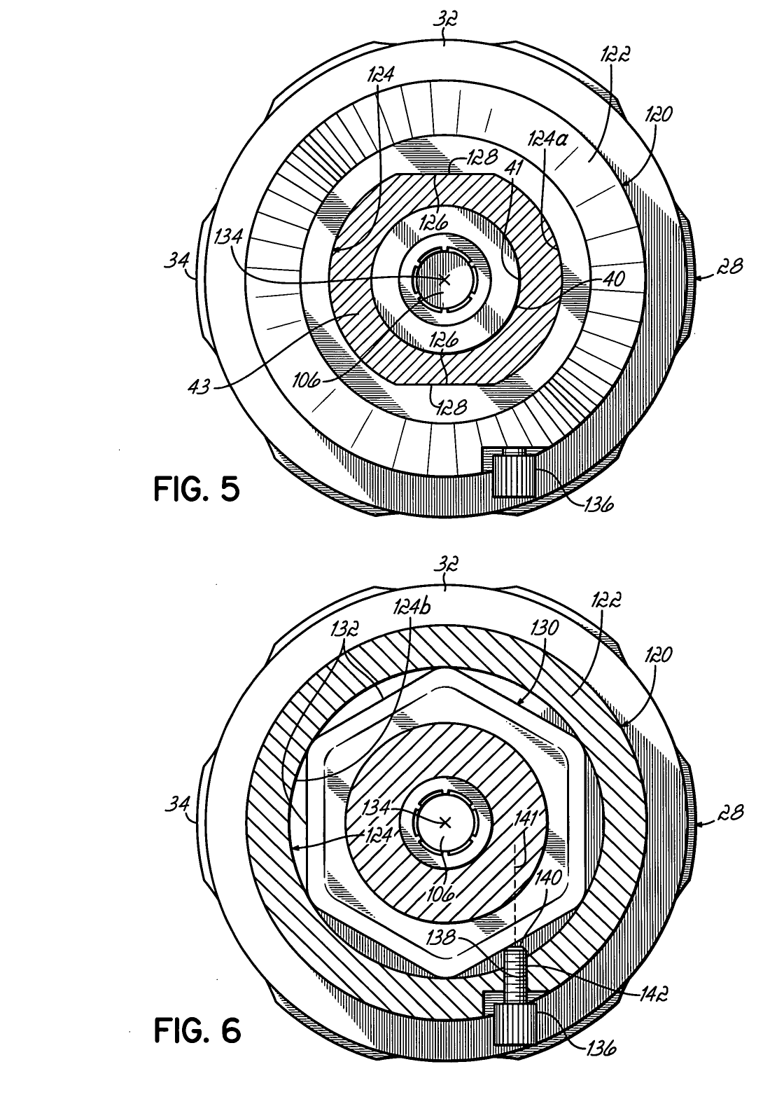

The collar 122 is registered angularly relative to the neck 43 such that bosses or surfaces, preferably flats 126 (FIG. 5), defined in the material of lock member 120 and positioned inside the circumference of a smaller-diameter portion 124a of bore 124 have a contacting relationship with corresponding bosses or surfaces, preferably flats 128, defined on the exterior of the neck 43. Contact between the surfaces of flats 126 and 128 prevents relative rotation between the fluid manifold 14 and the lock member 120. Flats 126 and 128 have corresponding angular spacings about the circumference of the bore 124 and neck 43, respectively, so that flats 126, 128 may be placed into alignment during assembly and installation. The portion 124a of bore 124 has a non-circular cross section that is interrupted by the presence of flats 126.

In the illustrated embodiment, a pair of flats 126 are substantially equivalent and diametrically-opposed, as well as a pair of flats 128 that are substantially equivalent and diametrically-opposed, so that the flats 126, 128 may be keyed and mutually engaged at two different angular orientations between neck 43 and a nut 130. That is, flats 126 lie in approximately parallel planes, as do flats 128. However, the invention is not so limited as, for example, three flats 126 may be provided within bore 124 and three flats 128 of corresponding relative angular spacing, preferably equal angular spacing, may be provided on neck 43.

The housing 32 of hydraulic fitting 28 includes integral nut 130 having faces 132 arranged about the circumference at locations suitable for grasping nut 130 with a tool for rotating the hydraulic fitting 28 relative to the fluid manifold 14 to tighten or loosen the threaded engagement between the threaded region 40 and internally-threaded inlet 42. In the illustrated embodiment, a plurality of six faces 132 are defined with a hexagonal arrangement about the circumference of nut 130. Although this provides compatibility with conventional tools used to engage nut 130 for tightening and loosening the threaded engagement between threaded region 40 and internally-threaded inlet 42, the number of faces 132 may differ and other arrangements are possible.

Spaced along a central axis 134 of bore 124 from portion 124a is an adjacent portion 124b of larger diameter than portion 124a and having a circular cross section. The nut 130 is partially positioned inside this larger-diameter portion 124b and, in particular, the faces 132 of nut 130 are at least partially positioned inside portion 124b. The diameter of portion 124b may be approximately equal to the diameter of a circle circumscribing nut 130, as shown in FIG. 5, or may be larger than the diameter of the circumscribing circle to provide additional clearance.

A threaded member, such as a set screw 136, penetrates through a threaded opening 138 defined in the side of the circular cross-section portion (FIG. 5) of collar 122. A tip 140 of the set screw 136 contacts one of the faces 132 on the integral nut 130. The specific face 132 contacted by a tip 144 of set screw 136 will depend upon the angular orientation of nut 130 relative to the location of the set screw 136. Typically, the faces 132 are substantially identical and any may be beneficially contacted by tip 144 when the set screw 136 is advanced to contact one of faces 132. The set screw 136 has a conventional head that may be engaged by a suitable tool for tightening and loosening the set screw 136.

The opening 138 is oriented relative to the central axis 134 of the bore 124 such that a centerline 140 extending along the length of a threaded shank or portion 142 of the set screw 136 does not intersect the central axis 134 of bore 124. In other words, the centerline 140 along which the set screw 136 advances and withdraws is offset from the central axis 134 so that the central axis 134 and centerline 140 do not intersect. As a result, the set screw 136 provides a torque or torsional force on the nut 130. The torsional force applied by the tip 140 of set screw 136 to the face 132 of nut 130 is transferred through the collar 122 to the flats 126. The torsional force is then retained by the flats 128 on the fluid manifold 14, thereby maintaining a tight threaded connection between the threaded region 40 on the housing 32 and the internally-threaded inlet 42 on the dispenser body 12.

Contact between the tip 140 of set screw 136 and the face 132 of nut 130 prevents relative rotation between the hydraulic fitting 28 and the collar 122 of lock member 120. Because the contact between flats 126 and flats 128 prevents relative rotation between the fluid manifold 14 and the lock member 120, as described above, it is apparent that the lock member 120 prevents relative rotation between the fluid manifold 14 and the hydraulic fitting 28. Rotation of nut 130 in a clockwise direction, as viewed in FIG. 5, is prevented, which is the direction that otherwise loosens the housing 32 of hydraulic fitting 28. Of course, opening 138 would be oriented differently to prohibit rotation in the clockwise direction, as viewed in FIG. 5, if the handedness of the threaded region 40 of housing 32 and the internally-threaded inlet 42 were changed.

In use and with reference to FIGS. 1-5, the lock member 120 is placed between the hydraulic fitting 28 and the neck 43 of the fluid manifold 14 with flats 126 on lock member 120 registered with flats 128 defined on the exterior of the neck 43. The set screw 136 is withdrawn from contact with nut 130 during assembly. Using a tool engaged with the faces 132 of integral nut 130, the hydraulic fitting 28 is rotated relative to the fluid manifold 14 to tighten the threaded engagement between the threaded region 40 and internally-threaded inlet 42. When a targeted level of tightness is attained to provide a fluid-tight connection between the fluid manifold 14 and hydraulic fitting 28, the set screw 136 is advanced until the tip 140 contacts one of the faces 132 of integral nut 130. After liquid flow is established, the hydraulic fitting 28 directs liquid from the supply conduit 22 to the fluid manifold 14.

As the operator moves about carrying the handheld dispenser 10, the stem 48 and ball 46 of hydraulic fitting 28 rotate and tilt to accommodate changes in orientation of the dispenser body 12. Torsional forces resulting from the operator's movement act in a direction that, if not counteracted and balanced, would otherwise cause the threaded region 40 on the housing 32 to rotate relative to the internally-threaded inlet 42 on the fluid manifold 14. Advantageously, the lock member 120 operates to prevent relative rotation between the threaded region 40 on the housing 32 and the internally-threaded inlet 42 on the fluid manifold 14. The torsional force transferred from the tip 140 of set screw 136 to the face 132 of nut 130 counteracts and balances the torsional force arising from the operator's movement such that a state of equilibrium is established. As shown in FIG. 5, the contact between the tip 140 of set screw 136 and one face 132 of nut 130 prevents rotation in a clockwise direction, which is a direction that would result in loosening of the hydraulic fitting 28 in response to torsional forces, were the lock member 120 not installed.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept. The scope of the invention itself should only be defined by the appended claims, wherein we claim:

1. A lock member configured to prevent relative rotation between a threaded portion of a hydraulic fitting and a threaded portion of a manifold engaged with the threaded portion of the hydraulic fitting, the lock member comprising:
a collar capable of being positioned between the threaded portions, said collar including a threaded opening and a portion capable of being engaged with the manifold to prevent relative rotation between said collar and the manifold; and
a threaded member having a threaded engagement with said threaded opening, said threaded member having a section capable of being placed in contact with the hydraulic fitting when the threaded portions are engaged so as to prevent rotation between said collar and the hydraulic fitting.

2. The lock member of claim 1 wherein said portion of said collar includes a surface positioned to be contacted by a complementary surface on the manifold so as to prevent rotation of said collar relative to the manifold.

3. The lock member of claim 1 wherein said collar includes a bore with a central axis, said bore adapted to receive a portion of the hydraulic fitting, and said threaded opening extends through said collar laterally relative to said central axis.

4. The lock member of claim 3 wherein the threaded portions are mechanically coupled through said bore.

5. The lock member of claim 3 wherein said threaded opening includes a centerline about which the threaded opening is symmetrical, said threaded opening having an angular orientation such that said centerline does not intersect said central axis.

6. A hydraulic fitting for transferring a fluid from a supply conduit to a manifold having a threaded portion and a fluid channel, comprising:
a body having a threaded portion capable of being engaged with the threaded portion of the manifold, said body hydraulically coupling the fluid channel of the manifold with the supply conduit when said threaded portion of said body is engaged with the threaded portion of the manifold; and
a lock member configured to prevent rotation of said threaded portion of said body relative to the threaded portion of the manifold when said threaded portion of said body is engaged with the threaded portion of the manifold.

7. The hydraulic fitting of claim 6 wherein said lock member includes a collar with a threaded opening and a threaded member having a threaded engagement with said threaded opening, said threaded member having a section capable of being placed in contact with said body when said threaded portion is engaged with the threaded portion of the manifold so as to prevent rotation of said lock member relative to said body.

8. The hydraulic fitting of claim 7 wherein said body includes a surface contacted by said portion of said threaded member, said surface of said body further configured for use in mechanically engaging said threaded portion of said body with the threaded portion of the manifold.

9. The hydraulic fitting of claim 7 wherein said collar includes a surface positioned to be contacted by a complementary surface on the manifold so as to prevent rotation of said collar relative to the manifold.

10. The hydraulic fitting of claim 7 wherein said collar includes a bore with a central axis, said bore adapted to receive a portion of the body, and said threaded opening extends through said collar laterally relative to said central axis.

11. The hydraulic fitting of claim 10 wherein said threaded portion of said body is mechanically coupled to the threaded portion of the manifold through said bore.

12. The hydraulic fitting of claim 7 wherein said threaded opening includes a centerline about which the threaded opening is symmetrical, said threaded opening having an angular orientation such that said centerline does not intersect said central axis.

13. The hydraulic fitting of claim 6 wherein said body includes a housing, a ball configured to rotate and swivel relative to said housing, and a stem coupled with said ball and projecting from said housing.

14. The hydraulic fitting of claim 13 wherein said housing includes fluid cavity and a socket assembly positioned in said fluid cavity, said ball is engaged for movement within said socket assembly and includes a bore, and said stem is received in said bore with a fluid-tight engagement, said stem includes a fluid passageway coupled in fluid communication with said fluid cavity, and said stem is axially movable along said bore for transferring an axial force directed along said stem to said housing.

15. A fluid dispenser for dispensing a fluid supplied from a supply conduit, comprising:
a manifold with a threaded portion and a fluid channel;
a hydraulic fitting having a threaded portion engaged with said threaded portion of said manifold, said hydraulic fitting hydraulically coupling said fluid channel of said manifold with the supply conduit; and
a lock member configured to prevent rotation of said threaded portion of said hydraulic fitting relative to said threaded portion of said manifold.

16. The fluid dispenser of claim 15 wherein said manifold includes a nozzle tip capable of dispensing the fluid from said fluid channel and a handgrip capable of being grasped for moving said manifold to orient the nozzle tip.

17. The fluid dispenser of claim 15 wherein said threaded inlet includes a surface and said lock member includes a complementary surface positioned to be contacted by said surface on said threaded inlet.

18. The fluid dispenser of claim 15 wherein said body includes a housing, a ball configured to rotate and swivel relative to said housing, and a stem coupled with said ball and projecting from said housing.

19. The fluid dispenser of claim 18 wherein said housing includes a fluid cavity and a socket assembly positioned in said fluid cavity, said ball is engaged for movement within said socket assembly and includes a bore, and said stem is received in said bore with a fluid-tight engagement, said stem includes a fluid passageway coupled in fluid communication with said fluid cavity, and said stem is axially movable along said bore for transferring an axial force directed along said stem to said housing.
